(19) United States
(12) Patent Application Publication
(10) Pub. No.: US 2014/0137555 A1
(43) Pub. Date: May 22, 2014

(54) METHOD AND APPARATUS FOR ELECTRIC CO-FIRING OF POWER GENERATION PLANTS

(71) Applicant: HYTERESIS, INC., Portland, OR (US)

(72) Inventors: Leonardo Andres DEL CAMPO, Long Beach, CA (US); Warren KATZENSTEIN, Oakland, CA (US)

(73) Assignee: Hyteresis, Inc., Portland, OR (US)

(21) Appl. No.: 13/682,407

(22) Filed: Nov. 20, 2012

(51) Int. Cl. F01K 13/02; H05B 1/02

(52) U.S. Cl. CPC F01K 13/02; H05B 1/023
USPC 60/646; 219/201

(57) ABSTRACT

The invention can be a method for maintaining an operating temperature of a power plant during shut-down periods. The method can include, during shut-down of the power plant, generating heat with an electric heater in order to approximately maintain the operating temperature of the power plant. The method can use electric power to operate the electric heater, where at least some of the electric power is from an electricity grid external to the power plant. The method can continue to generate heat with the electric heater as long as at least one of the electrical prices and the demand for electricity indicate that it will be more efficient to use electric power from the electricity grid to generate heat with the electric heater than to more completely shut down or restart the power plant.

### FIELD OF THE INVENTION

This invention relates generally to the field of power generation plants.

### BACKGROUND

Operating an electric grid can be complicated by several factors. First, an electric grid can include a multitude of connected power generation plants and types of power sources that must be integrated into the electric grid. Second, the electrical grid must keep up with variations in power demand. Third, the electric grid must respond to changes in demand throughout the day, week and year, by economically controlling the multitude of power plants. These factors lead to the shutting down of some power plants when they are not needed or when electricity can be generated more cheaply elsewhere.

A coal power plant is typically shut down when the price of electricity is less than the coal plant's price to produce electricity or when the revenue from producing electricity is less than the coal plant's variable operating and maintenance expenses including startup and shutdown of the plant costs. If the power plant is operated when the price of electricity from the electrical grid is less than the power plant's price to produce electricity, it will lose money. The power plant will be restarted when the price of electricity from the electrical grid is greater than the power plant's price to produce electricity or when the revenue for operating the power plant is greater than the plant's variable operating and maintenance costs including startup and shutdown costs. Shut-down and restart of a coal power plant, however, incurs costs from different sources, including operational costs in the form of fuel used to bring the power plant systems up to operating temperature and maintenance costs from damage associated with thermal cycling.

A need exists for a method and system to solve problems and reduce costs associated with shut-down of power plants.

### SUMMARY OF INVENTION

According to one embodiment, the invention can be a method for maintaining an operating temperature of a power plant during shut-down periods. In this embodiment, the method can include, during shut-down of the power plant, generating heat with an electric heater in order to approximately maintain the operating temperature of the power plant. The method can use electric power to operate the electric heater, where at least some of the electric power is from an electricity grid external to the power plant. In addition, the method in this embodiment can include receiving feedback from temperature readings of parts of the power plant, as well as monitoring electrical prices from the electricity grid or demand for electricity (or both), and then using this information to control the electric heater. In particular, the method can include continuing to generate heat with the electric heater as long as (i) the power plant is shut-down and the feedback from the temperature readings indicate a need to heat the power plant to approximately maintain the operating temperature of the power plant, and (ii) at least one of the electrical prices and the demand for electricity indicate that it will be more efficient to use electric power from the electricity grid to generate heat with the electric heater than to more completely shut down or restart the power plant.

The electric heater can be a resistive heating element heater or an inductive heating element heater. In addition, the invention can also include blocking an exhaust system of the power plant to prevent hot gases from exiting the power plant. Blocking these gases can help maintain the operating temperature of the power plant when it is in shut-down mode. A valve, for example, can be used to block hot air from exiting an exhaust flue. Further, the invention can include using circulation fans within the power generation unit to retain heat within the power generation unit.

“Shut-down” is a period of time in which the power plant is not producing a meaningful amount of power for the electrical grid. As used herein, the term “shut-down” does not necessarily mean that the power plant or a power generation unit is completely shut down. Instead, it means that the power plant or power generation unit is not producing a meaningful amount of power for the electrical grid. Small amounts of power might still be produced during “shut-down,” but these amounts of power are not close to the typical power output during operation of the power plant. These small amounts of power, for example, won't be for the electrical grid. As an example, a power generation unit or power plant can be in shut-down mode, but the power generation unit or power plant can still use the electric heater to maintain its operating temperature. In contrast, a more complete shut-down of the power generation unit or power plant can involve not using the electric heater so that the power generation unit or power plant is not maintained at its operating temperature.

“Restart” is the process of bringing a power generation unit or power plant back up after a complete shut-down of the power generation unit or after a shut-down period in which the electric heater is used to maintain its operating temperature, so that the power generation unit or power plant can generate power for the electrical grid. The “operating temperature” of a power plant is the approximate temperature at which the power generation unit or power plant operates when producing electricity for the electrical grid or within a small temperature lower than the temperature during power production. During a shut-down period in which the electric heater is used to heat the power generation unit or power plant, the temperature of the power generation unit or power plant may be maintained at approximately its operating temperature. For example, when the electric heater is used, the operating temperature of the power generation unit or power plant may be maintained within a few degrees of its temperature during power production. Alternatively, when the electric heater is used, the operating temperature of the power generation unit or power plant may be such that it will take approximately 1 hour to start up for power production. This can be referred to as a “hot” start of the power generation unit or power plant. Alternatively, the operating temperature of the power generation unit or power plant may be such that it will take approximately 4 hours to start up for power production. This can be referred to as a “warm” start of the power generation unit or power plant. Finally, a “cold” start of the power generation unit or power plant can be when it will take approximately 10 or more hours to start up for power production. In any event, when the electric heater is used, the power generation unit or power plant can be maintained within the warm or hot restart ranges, and this can still be considered to be the approximate operating temperature of the power plant as the term operating temperature is used herein. The power generation unit or power plant, however, may still be in shut-down mode when it is within this range. On the other hand, a more complete shut-down of the power generation unit or the power plant involves entering the cold restart range described above.

In the method described above, in addition to temperature readings, feedback can be received regarding pressure readings, steam and water flow readings, and/or hot air flow readings. These readings, in turn, can be used to determine the need to heat the power plant to approximately maintain the operating temperature of the power plant when it is in shut-down mode.

In another embodiment, the invention can be a heating system for maintaining an operating temperature of a power plant during shut-down periods. In this embodiment, the system can include an electric heater and a control system (or control unit). The electric heater can be used to generate heat to approximately maintain the operating temperature of the power plant during shut-down of the power plant, and the electric heater can use electric power from an electricity grid external to the power plant. The control system can receive feedback from temperature readings of parts of the power plant. In addition, the control system can monitor electrical prices from the electricity grid or receive commands from the grid operator or a governing agency. In response to this information, the control system can continue to generate heat with the electric heater as long as the power plant is shut-down and the feedback from the temperature readings and the electrical prices indicate that it will be more efficient to use electric power from the electricity grid to generate heat with the electric heater than to more completely shut down or restart the power plant.

In this system, it is also possible to use a valve to control an exhaust flue of the power generation unit or power plant in this embodiment. The valve can be closed, for instance, in order to help maintain the operating temperature of the power generation unit or power plant when it is in shut-down mode. In addition, the control system can control this valve. Further, in addition to temperature readings, the control system can receive feedback of pressure flows, water flows, and air flow rates, and the control system can use this feedback to control the electric heater and/or the valve. Further, it is possible to use the control unit to control the fans of the power generation unit to retain heat within the unit when in the shut-down mode.

Yet another embodiment of the invention is a method for maintaining an operating temperature of a power generation unit during shut-down periods. In this embodiment, the method includes, during shut-down of the power generation unit, generating heat with an electric heater in order to approximately maintain the operating temperature of the power generation unit. Electric power can be used to operate the electric heater, where the electric power is from a power unit that is external to the power generation unit. In addition, in this embodiment, the method can include receiving feedback from operational readings of parts of the power generation unit. These operational readings can include, for instance, temperature, pressure, and air and water flow rate information. Finally, in this embodiment, the method can continue to generate heat with the electric heater as long as the power plant is shut-down and the feedback from the operational readings requires generation of heat to approximately maintain the operating temperature.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a flow chart for operation of one embodiment of the invention;

FIG. 2 is a block diagram of a system according to one embodiment of the invention;

FIG. 3 is a flow chart for a control scheme that can be used by the control unit in order to perform at least some functions of one embodiment of the invention;

FIG. 4 is an exemplary power generation unit for a power plant, such as a coal-fired generator, in which the embodiments of FIGS. 1-3 may be used;

FIG. 5 is an exemplary section of a power plant of FIG. 4, including a heater in accordance with some embodiments of the invention;

FIG. 6 is an example of a resistive heater affixed to a pipe according to one embodiment of the invention;

FIG. 7 is an example of an inductive heater adjacent to a pipe according to one embodiment of the invention;

FIG. 8 is an example of an inductive heater affixed to superheating piping that may be used according to one embodiment of the invention; and

FIG. 9 shows a valve that may be used according to one embodiment of the invention.

### DETAILED DESCRIPTION

To address the need set forth above, according to one aspect, the invention relates to a an improvement to power plants that may be a retrofit or may be applied to future power plants that use heat to raise steam in order to generate electricity. Some examples of these types of power plants are coal, oil, nuclear, and natural gas-fired power plants. In brief, in some embodiments, the invention includes the use of one or more electric heaters to keep the appropriate systems of the power plant near operating temperature during shut-down periods. These embodiments of the invention can also include the use of electric heating equipment and control schemes. The electric heater can be used for one power generation unit of a multi-unit power plant, and the electric heater can also be used for the entire power plant.

For example, in one embodiment, a method according to the invention can include, during shut-down of a power generation unit, generating heat with an electric heater in order to approximately maintain the operating temperature of the power generation unit. This embodiment uses electric power to operate the electric heater, and the electric power is from a power unit that is external to the power generation unit. Further, this embodiment can include receiving feedback from operational readings of parts of the power generation unit, and then continuing to generate heat with the electric heater as long as the power generation unit is shut-down and the feedback from the operational readings requires generation of heat to approximately maintain the operating temperature.

A multitude of factors affect electricity prices, including time of day, weather conditions, and demand. More complexity is introduced with the increasing proportion of renewable sources that are frequently used to produce power in the electricity grid. Government policies can prioritize renewable sources, leading to coal power plant shut-downs when renewable sources are sufficient to meet demand. However, many renewable energy power plants are unreliable because their power production varies with the availability of their particular energy source. For example, a wind farm depends on sustained windy conditions and solar energy farms are very sensitive to cloud cover. These dependencies can result in tremendous variability in power production during the course of a week or even a single day. Additionally, incentives for renewable power generation are common and encourage renewable resources to submit low energy bids to avoid being curtailed. These incentives can also encourage renewable power generation sources to bid negative prices or bid low prices because they have no fuel cost (no variable cost of production). The result is that periods of cheap electricity prices may require coal or other fossil fuel or nuclear plants to shut down for hours at a time, when normally, without the presence of renewable resources, they would operate. According to the embodiments described herein, electric heaters keep the power generation unit or power plant near operating temperature by consuming electric power during periods of time when the plant is in shut-down mode. This can, in turn, make it less expensive to restart the power generation unit or power plant after the shut-down period ends and the power plant is brought back online to produce power for the grid.

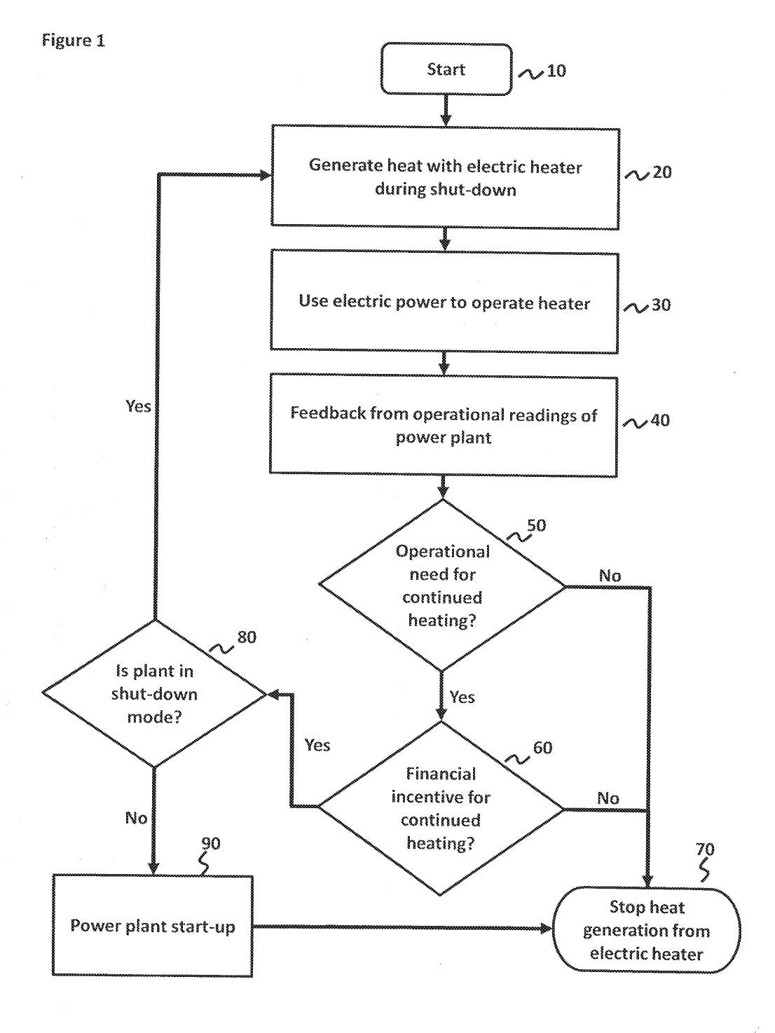

FIG. 1 is a flow chart for operation of this embodiment of the invention. At step 10, the operation begins. At step 20, heat is generated with an electric heater during shut-down of a power generation unit or a power plant. The heat from the electric heater is applied to the pipes or other structures within the power generation unit or the power plant. As described above, and as reflected in step 30, this embodiment uses electric power to operate the electric heater, and this electric power can be from the electricity grid or from a power unit that is external to the power generation unit. The heat from steps 20 and 30 can be used to approximately maintain the operating temperature of the power generation unit or the power plant. Step 40 indicates a step of receiving feedback from operational readings of parts of the power generation unit or power plant. This feedback can include, for example, pressure readings from pipes of the power generation unit or power plant, readings of steam and water flows in the power generation unit or power plant, readings from hot air flow in the power generation unit or power plant, and/or temperature readings from parts of the power generation unit or power plant.

Steps 50 and 60 indicate control steps for this embodiment of the invention. At step 50, a determination is made as to whether the operational readings (such as, but not limited to, pressure readings, steam and water flow readings, hot air flow readings, and/or temperature readings) indicate a need for heat from the electric heater to approximately maintain the operating temperature of the power generation unit or the power plant. If the answer is that there is no need for heat to maintain the operating temperature, then, as reflected in step 70, heat will stop being generated with the electric heater, and electric power will not be used to operate the electric heater. If, on the other hand, the answer is that there is still a need for heat to maintain the operating temperature, then the next step (step 60) in the flow chart can be performed.

At step 60, a determination is made as to whether electrical prices and/or demand for electricity indicate that it will be more efficient to use electric power to generate heat with the electric heater than to more completely shut down or restart the power generation unit or the power plant. This step can determine whether sufficient financial incentives exist for heating using the electric heaters. Additional information about how this determination can be made is set forth in the following sections. If the answer is that it will not be more efficient to use electric power to generate heat with the electric heater, then, as reflected in step 70, heat will stop being generated with the electric heater, and electric power will not be used to operate the electric heater. If, on the other hand, the answer is that it will be more efficient to use electric power to generate heat with the electric heater, then the next step in the flow chart will be performed.

Some embodiments of the invention, such as that set forth in FIG. 1, use both steps 50 and 60 to determine whether to continue to generate heat with the electric heater. Other embodiments of the invention, on the other hand, use only step 50, and not step 60. Still other embodiments of the invention use only step 60, and not step 50.

The next step in the flow chart of the embodiment of FIG. 1 is to determine if the power generation unit or the power plant is still in shut-down mode, as reflected in step 80. If the power generation unit or the power plant is no longer in shut-down mode, the power generation unit or the power plant can be restarted, as shown in step 90. If the power generation unit or the power plant is restarted, heat will stop being generated with the electric heater, and electric power will not be used to operate the electric heater, as reflected in step 70. If, on the other hand, the power generation unit or the power plant is still in shut-down mode, the flow chart will revert to step 20, and the method will continue to generate heat with the electric heater. The process will then repeat.

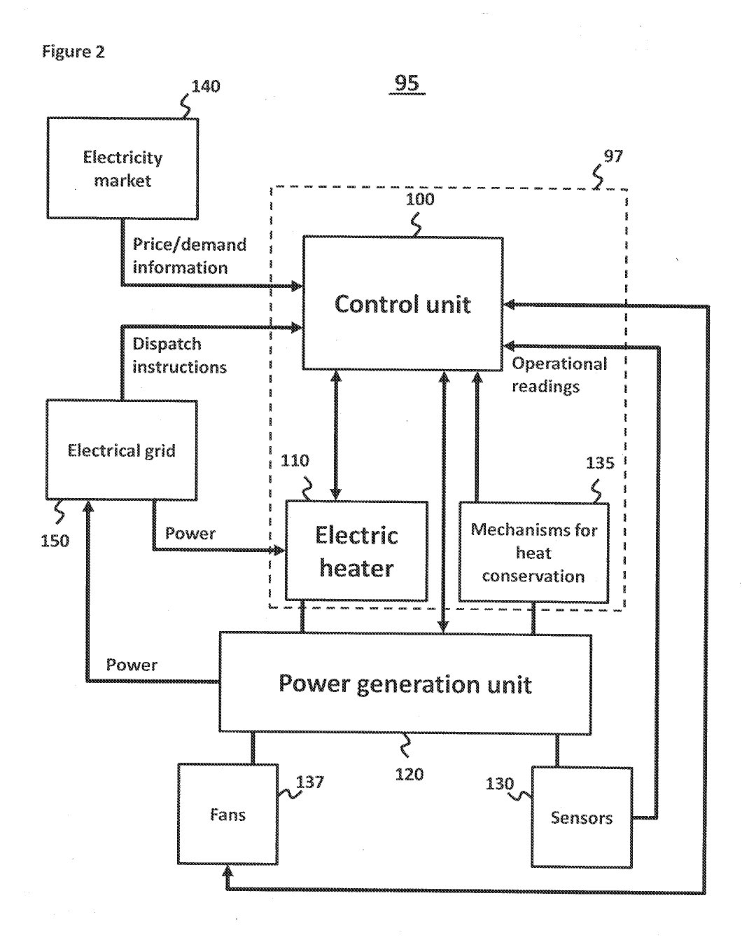

FIG. 2 is a block diagram of a system 95 according to one embodiment of the invention. The system 95 can be used to practice the method set forth in FIG. 1 and explained above. The system 95 includes a control unit 100, an electric heater or heaters 110, a power generation unit 120 (or a power plant), one or more sensors 130, a valve 135 for exhaust, fans 137, and use of the electrical grid 150 and electricity market data 140. In practice, the control unit 100, electric heater 110, and a mechanism for heat conservation 135 (such as a valve 135 for exhaust) can form a unit 97 that can be used to retrofit an existing power generation unit or power plant. Alternatively, the unit 97 can be built into a new power generation unit or power plant.

The power generation unit 120 or power plant can be any type of power plant that raises steam in order to generate electricity, such as coal, oil, nuclear, and natural gas-fired power plants. Some power plants include several independent power generation units 120. In FIG. 2, the power generation unit 120 label can be for any one or more of these power generation units 120. Collectively, all of these power generation units 120 can form the power plant. The numeral 120 will be used to refer to one or more of these power generation units or to the entire power plant.

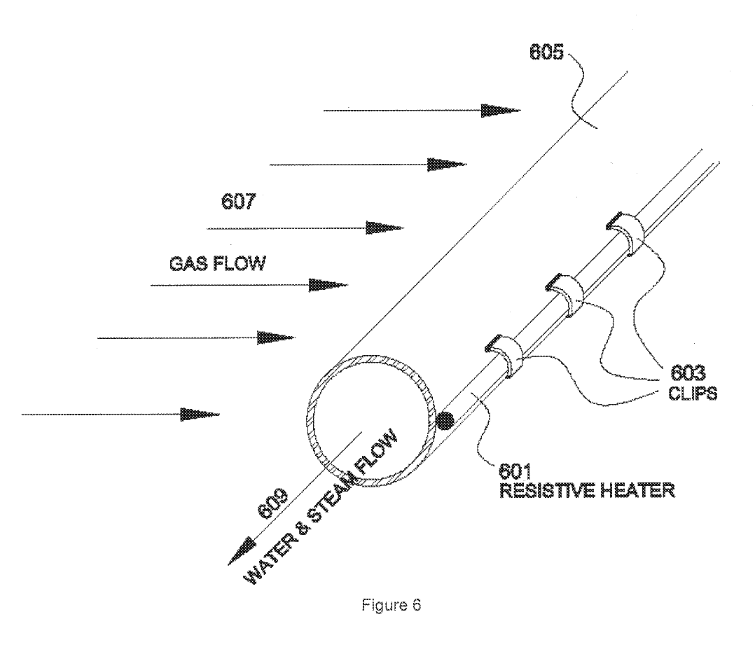

In an embodiment with only a single power generation unit 120, the electric heater 110 can include one or more electric heaters that connect to parts of the power generation unit 120 in order to, when in use, heat the power generation unit 120. In an embodiment with multiple power generation units 120, a plurality of electric heaters 110 can be used so that each power generation unit 120 has at least one such heater 110. In practice, a plurality of electric heaters 110 can be used with a single power generation unit 120 in order to appropriately heat the power generation unit 120 when the heater 110 is in use. The electric heater 110 can be a resistive heating element. In other embodiments, the electric heater 110 can be an inductive heating element. Various types of electric heaters 110 are set forth in greater detail below. Regardless of which type of heater 110 is used, the heater 110 can be coupled to one or more parts of the power generation unit 120 in order to heat it when needed. In particular, the electric heater 110 can be coupled to a pipe for steam, air, or water in the power generation unit 120. Examples of such coupling of an electric heater 110 to a pipe are set forth below and in FIGS. 6-8.

The one or more sensors 130 can include, for example, a pressure sensor to read the pressure in pipes of the power generation unit 120, air flow meters to measure the air flow in pipes of the power generation unit 120, pressure or velocity meters to read steam and water flows in the power generation unit 120 or power plant, and/or a thermometer to read the temperature from one or more parts of the power generation unit 120 or power plant. These sensors 130 can be any types of sensors known in the art.

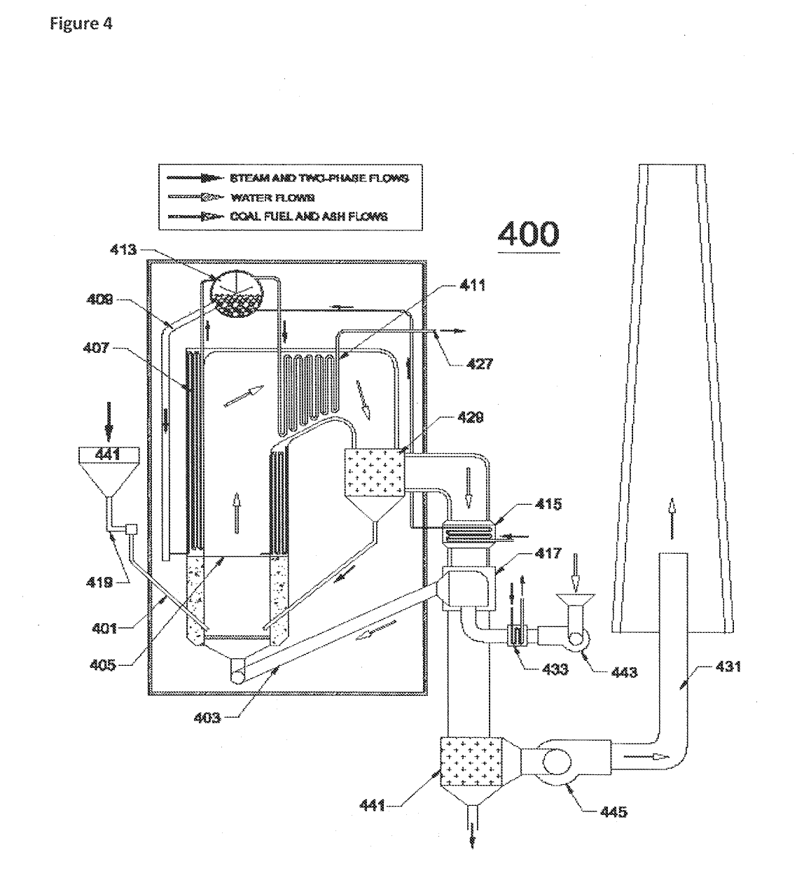

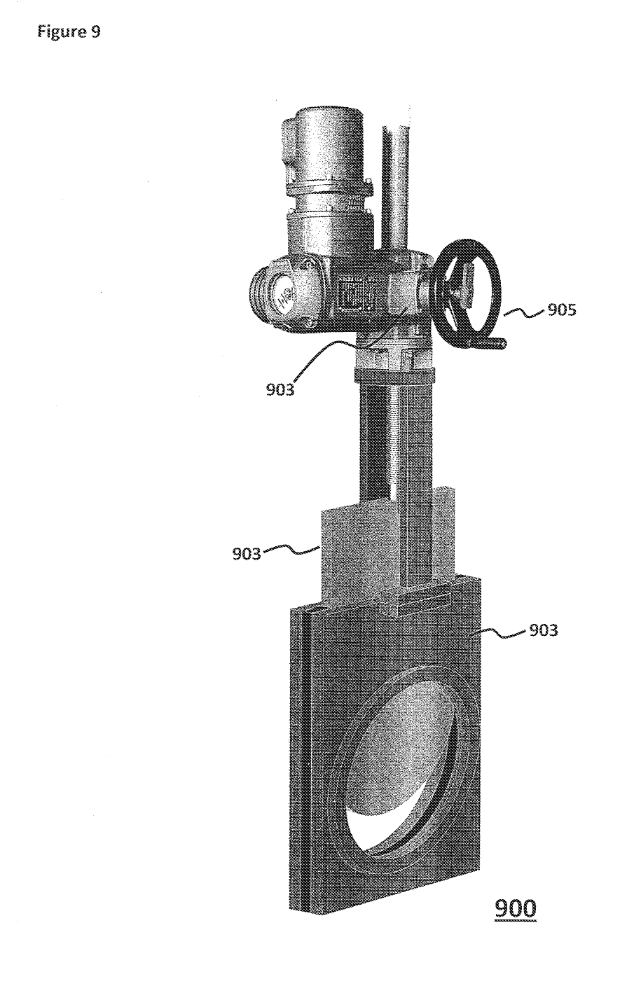

The mechanisms for heat conservation 135 can be, for example, one or more valves. The valve 135 for exhaust can be a valve that is used to control the flow through an exhaust flue of the power generation unit 120. The valve 135 can be opened to allow exhaust air to flow from the power generation unit 120. The valve 135 can be closed to retain heat within the power generation unit 120 when the power generation unit 120 is in shut-down mode. Using the valve 135 to block the exhaust flue can retain heat within the power generation unit 120, which can be desirable at certain times, as described in more detail below and in connection with FIGS. 4 and 9.

The fans 137 can include two fans, both of which can be part of a typical power generation unit. One of the fans, as described in more detail below, creates a positive pressure to introduce combustion air, and can be called a forced draft fan. The second fan can be located near the exhaust flue of the power plant called an induced draft fan. In use, the fans 137 can control the air flow through the power generation unit in order to retain heat within the power generation unit, as described in more detail below.

As shown in FIG. 2, the power generation unit 120 is connected to the electricity grid 150 so that power can be supplied to the electricity grid 150 when the power generation unit 120 is in operational mode and is producing power. At other times, and in particular when the electric heater 110 is used to generate heat, the power generation unit 120 does not provide power to the electricity grid 150. The electricity grid 150 (or electrical grid) is an electricity network that includes electricity generation (such as power plants), the electric power transmission network or lines to transmit power, and the electrical distribution system. Collectively, these elements make up an electricity grid 150 that serves either an electric utility, region, state, or country.

The electricity market data 140 can be a data source that provides real-time information about the price and/or demand of electricity in the electrical grid. This price and/or demand information can be for an electric utility, region, a state, or a country. In addition, this price and/or demand information can include a forecast for the near future (i.e., for at least the next several hours). FIG. 2 depicts this electricity market data 140 as being separate from the electricity grid 150, but it can also be part of the electricity grid 150. The control unit 100, for instance, would receive dispatch instructions from the operator of the electricity grid and/or would receive price information from the operator. The price information can be used for determining whether to use the electric heaters 110, while the dispatch instructions can be used for dispatching the power plant. Typically, some entity outside of the power plant determines when it is optimal to dispatch the power plant and when it is not. This can be done based on either price bids (for markets) or cost (in regulated markets).

The control unit 100 can include any type of control unit known in the art. The control unit 100 can include, for instance, one or more computers, microprocessors, controllers, or microcontrollers. The computer, microprocessor, controller or microcontroller can be of any type known in the art. In use, the computer, microprocessor, controller or microcontroller can interact with firmware or software, stored in a memory or any computer readable medium, that contains instructions to perform the operations set forth herein. In embodiments where a user can monitor the control of the electric heater 110 and power generation unit 120, the control unit 100 can also include user interface modules and software, including a screen or display, a keyboard, and a mouse. In embodiments where an existing power generation unit or power plant is retrofit to perform the invention described herein, the control unit 100 can be any computer, microprocessor, controller, or microcontroller that is already in use for the power generation unit or power plant. In this case, the logic to perform the operations can be supplied to the control unit by software or firmware.

The control unit 100 receives information from at least the electricity market data 140 (or electrical grid 150) and the sensors 130. The control unit 100 is also coupled to the electric heater 110, the fans 137, and the valve 135 so that it can control the electric heater 110, the valve 135, and/or the fans 137. In addition, in some embodiments, the control unit 100 can also receive information from the electric heater 110, the valve 135, and/or the fans 137. This information can include, for instance, performance information, temperature information, or the percent “on” information for the electric heater 110. In addition, this information can include performance information, pressure information, temperature information, or percent “on” information for the valve 135 and/or fans 137.

In operation, the system 95, including the unit 97, can be used to perform the method set forth above in connection with FIG. 1, as well as additional methods. In particular, the control unit 100 is connected to the electric heater 110 in order to control the electric heater 110, and in particular, to control when it is used to generate heat. In addition, the control unit 100 is connected to the valve 135 in order to control it, and in particular, to control it to close the valve 135, blocking the exhaust flue, when it is desired to retain heat within the power generation unit 120. The control unit 100 can also open the valve 135 at other times. Further, the control unit 100 is connected to the fans 137 to control them, and in particular, to control the fans to retain heat within the power generation unit 120 when in shut-down mode. For example, the control unit 100 receives operational readings from the sensors 130. The control unit 100 can use these operational readings to determine when to turn on and turn off the electric heater 110, as well as when to open and close the valve 135 and control the fans 137.

In embodiments using the electric heater 110, in general, electric heat would be applied to the power generation unit 120 with the electric heater 110 during periods of time when electricity prices are favorable. Maintaining higher temperatures of the power generation unit 120 in this way reduces thermal cycling and therefore reduces operating costs through avoided maintenance, reduced fuel consumption, and faster response during start up. The electric heaters 110, valve 135, and control unit 100 can, for example, be installed as a retrofit to existing power plants. Alternatively, electric heaters 110, valve 135, and control unit 100 can be included in the design of new power plants. Thus, in this embodiment, the invention introduces a capability for a power generation unit 120 to consume electric power from the electricity grid 150 in order to generate heat. The heating system of the power generation unit 120 can receive feedback from the sensors 130 (such as temperature readings, pressure readings, and steam and air flow readings from the piping and other structures). The control unit 100 in the power generation unit 120 can use these readings and information to control the amount of heat needed from the electric heater 110 when the power generation unit 120 is in shut-down mode. Many of the pipes will contain liquid water or steam even though the power generation unit 120 or power plant has been shut down. As heat is applied to the pipes, additional water will be boiled, cooling the pipes through the consumption of heat for water vaporization. This heated water and steam may require circulation via pumps, due to rising steam pressures and specific power generation unit 120 design requirements. Both of the aforementioned processes will consume electricity during electric heating operation.

In these embodiments, as set forth above, the control unit 100 will run a control scheme to operate the electric heaters 110 and/or valve 135 based on physical conditions of the power generation unit 120, such as, for example, temperature, pressure, or air flow readings from the sensors 130 in the power generation unit 120. In addition, a financial analysis can be used to determine the operation of the electric heaters 110 and/or valve 135 to reduce operating costs. The control scheme will be used to determine when and how to operate the electric heaters 110 and/or valve 135 and to control the transition between traditional fossil fuel or nuclear fuel operation of the power generation unit 120 and electric heating of the power generation unit 120. The control unit 100 is designed to ensure the safe operation of the power generation unit 120 based on decisions to use the electric heaters 110 and/or valve 135 that minimize operation and maintenance costs. The decision to operate or not operate the electric heaters 110 can be based on both the operational readings of the power generation unit 120 and a financial analysis of operating and maintenance costs of using the electric heaters 110 to maintain the operating temperature compared to more completely shutting down the power generation unit 120. As examples, the control scheme can perform the following functions. Upon receiving feedback of pressure readings for pipes of the power plant or power generation unit, the control scheme can use the pressure readings to determine the need to heat the power plant to approximately maintain the operating temperature of the power plant. Further, upon receiving readings of steam, hot air, and water flows in the power plant, the control scheme can use this information to determine the need to heat the power plant to approximately maintain the operating temperature of the power plant. Finally, the control scheme can be used to completely shut down the power plant when either or both of the electrical prices and the demand for electricity indicate that it will be more efficient to completely shut down the power plant than to use electric power from the electricity grid to generate heat with the electric heater. The control unit 100, therefore, can directly control the power generation unit 120 to perform this task.

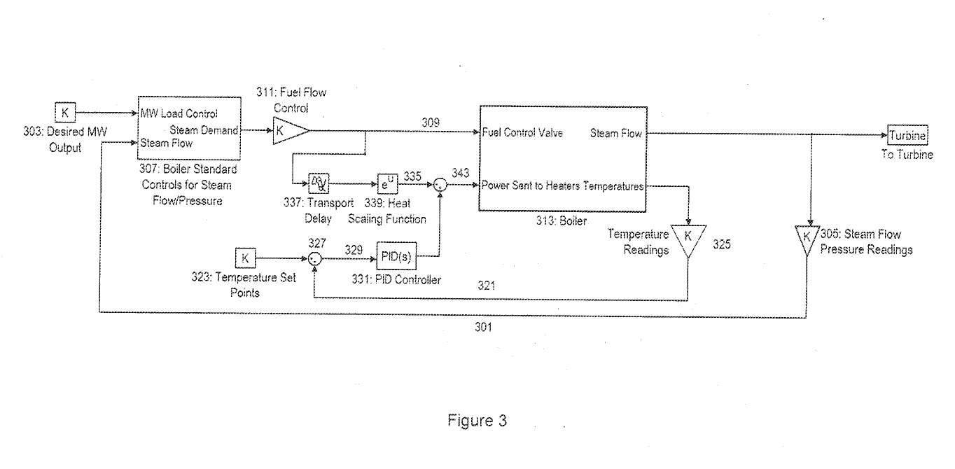

The primary function of the control scheme is to maintain temperatures, pressures, and fluid flows in the necessary sections and components of the power generation unit 120. The control unit 100 can manage the amount of electric heating applied to sections and parts of the plant. The control scheme will try to minimize, up to a given deadband to allow for observed levels of noise in measurement readings, the error between set points for temperature, pressure, water and steam flows, and their respective actual observed states (or observed states through the use of a state estimator). The control scheme, for example, can be a closed loop control scheme that includes proportional, proportional plus integral, or proportional plus integral plus derivative control. Such a control scheme can ensure system stability and may incorporate feed-forward terms for improved response times. One exemplary control scheme for closed loop control is shown in FIG. 3. The control scheme has two components (or loops). The first loop 301 is the normal boiler controls a power plant has (the outer loop 301 in FIG. 3) that takes a desired megawatt (MW) control setting 303 as an input that feeds into the power plants standard boiler controls. The boiler controls are complex and proprietary, and primarily use steam flow and pressure readings 305 to determine appropriate steam demand 307, which is then translated to fuel flow 309 via the fuel flow control 311. The fuel flow control signal 309 is then sent to the fuel control valve 313 that adjusts fuel into the boiler. The boiler reacts and new steam flow and pressure readings are made and the process repeats. The second loop (the inner loop 321) is the new addition that controls the electric heaters. The primary difference is that it is a temperature-based control rather than a steam flow and pressure-based control. The heaters are activated by desired temperature set points 323 determined by plant operators that are appropriate for their plant. They can also be set at the temperatures the plant is currently operating at when it is desired to use the electric heaters (to maintain current temperature). Because there can be multiple heaters and the boiler can be at multiple temperatures, the control scheme can be based on more than one temperature set point 323. The current temperatures from temperature readings 325 are subtracted 327 off the desired temperature set points 323. This is then the error 329 between desired and actual temperatures. The error 329 feeds into the PID controller 331, which is tuned to minimize the error 329. The PID controller 331 outputs control signals 333 for the heater (the desired power consumption or heat input). Subtracted from the PID control signal 333 is the estimated heat input 335 coming from the fuel flow control 311. This is a feed forward component of the control loop and is designed to allow for startup and shutdown periods when the power plant is operating in a hybrid mode (both heaters and coal combustion are taking place). The transport delay 337 recognizes that there is a delay between adjusting fuel flow and seeing a rise or decline in heat in various parts of the boiler. The heat scaling function 339 takes the fuel flow control signal and transforms it into the equivalent signals for controlling the heaters that would produce approximately the same heat and get approximately the same temperature. Subtracting this equivalent signal 335 from the PID signal 333 in block 341 results in the actual control signal 343 sent to the electric heaters. Temperature readings are then taken for the observed sections of the boiler and compared to the set points and the loop starts over again.

FIG. 4 illustrates existing technology for coal-fired power plants 400. The structure of FIG. 4 can be used as the power generation unit or the power plant described above. In FIG. 4, coal fuel is loaded through the fuel chute 401 and mixed with air inserted in the primary air duct 403. This fuel and air can be burned in the area of the power generation unit below the refractory line 405. Combustion gases rise and heat the wing walls 407, which consist of piping fed with water and steam flows from the downcomer pipe 409. Further water and steam heating takes place in the superheater 411, which also consists of high temperature piping filled with steam and water flows. Many power plant designs include multiple superheaters as required for specific flows and temperatures. The superheater sections 411 function to heat the steam and water flows from the steam chest or steam drum 413. Typically, the steam chest 413 is the location for steam collection for use in power generation. The steam chest 413 usually includes a system for separating steam and condensed water, and is also the location for water collection flowing to the downcomer 409 as previously explained. Combustion gases continue to the economizer 415, where water is pre-heated. Finally, combustion air is pre-heated in the air heater 417. Operating temperatures for components are highest in the wing wall 407, which is sometimes referred to as the furnace walls. Collectively, the system described above is sometimes referred to as a steam generator, heat recovery steam generator, or “HRSG.” Several other components of the unit 400 are also shown in FIG. 4. These components include a gravimetric feeder 419, feedwater to drum 427, multi-cyclone dust collector 429, exhaust flue 431, steam coal air heater 433, and fuel bunker 441. These components are known in the art. FIG. 4 also includes a particulate filter 441, forced draft fan 443, and induced draft fan 445.

The existing technology for coal power plants is intolerant of throttling and temporary shut downs. Minimizing the time and costs required to bring the plant from a non-productive condition to a normal power production condition is a design concern for current state of the art power plants. There is an incurred cost manifested in fuel and time needed to reach operating condition and in maintenance on piping in the plant. Most of the high temperature heat exchanger areas of coal plants use high nickel alloys such as Inconel, which is strong and oxide-resistant at steady high temperatures, but is not tolerant to repeated thermal cycles, resulting in oxidation, fatigue, and loss of strength. Specifically, the amount of piping found in the furnace walls (or wing wall 407) and superheater 411 and the higher temperatures needed in these areas make them sensitive to thermal cycling. The power plant may continue to consume coal at low levels in order to attempt to maintain operating temperatures without producing unwanted power, but doing so can result in uneven heating and undesirable cooling, particularly in the secondary superheater, which is further from the furnace section of the power plant and receives its heat from convection of burned gases exiting the furnace.

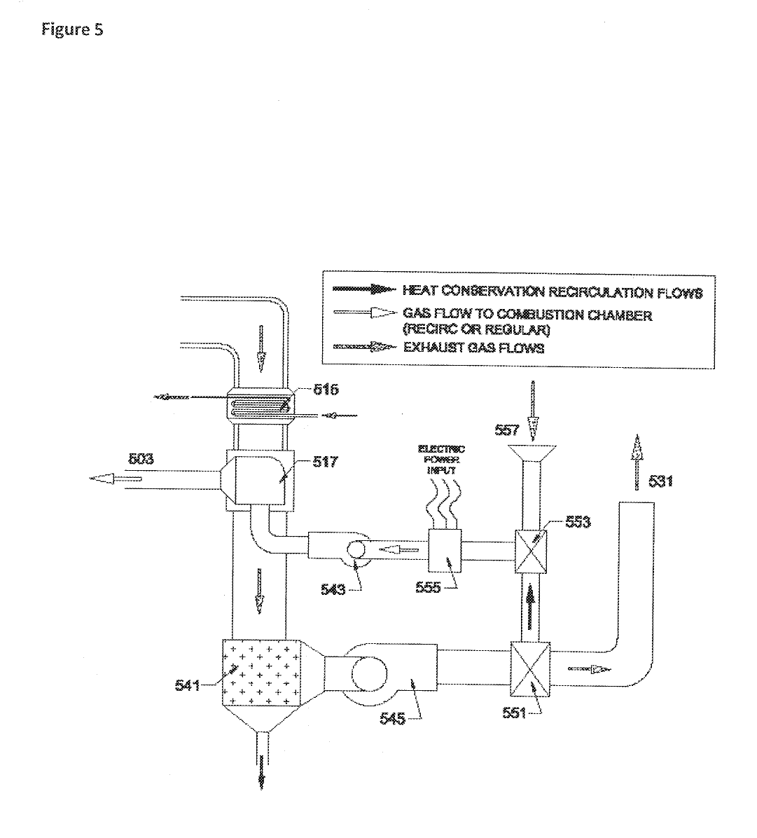

FIG. 5 is an example of a heat circulation subsystem for a coal fired power plant, which can be used in the embodiment of FIG. 4. FIG. 5 shows a water inlet and preheater 515 (similar to 415 in FIG. 4), an air preheater 517 (similar to 417 in FIG. 4), an air duct 503 to combustion chamber (this duct will be modified to accept higher temperatures than under normal operation), an ash and dust collector 541 or particulate filter (similar to 441 in FIG. 4), an induced draft fan 545 (similar to 445 in FIG. 4), a forced draft fan 543 (similar to 443 in FIG. 4), and an exhaust flue 531 (similar to 431 in FIG. 4) for normal operation. FIG. 5 also shows, as described herein, a bypass valve 551 to recirculate exhaust gas, a bypass valve 553 to block incoming cold air, an electric air heater 555 as described herein, and, if desired for electric air heating, normal air inlet 557. The electric heater 555 can be placed in a variety of locations within the power plant. As described herein, the electric heater(s) 555 can be used to heat the power generation unit. The bypass valve 551 can be used to recirculate exhaust gas to retain heat, as described herein, and the bypass valve 551 can be used in connection with bypass valve 553.

FIG. 6 is an example of resistive heating element 601 used to heat a pipe 605 within a power generation unit. The heating element 601 can be connected to a pipe in, for example, a furnace or superheater section of the power plant (such as a coal power plant). In this example, the heating element 601 is attached to the back of a pipe 605 with clips 603. FIG. 6 shows the use of three clips 603 for this purpose, but more or less can be used in other embodiments. In this embodiment, the clips 603 can be made from suitable metal material, such as Inconel, and the clips 603 can be welded to the pipe 605 to fix the heating element 601 to the pipe 605. In FIG. 3, the heating element 601 has been affixed to the pipe 605 such that the heating element 601 is oriented on the pipe surface so that it disrupts the gas flow 607 and heat transfer from the combustion gases to the pipes as little as possible. In other embodiments, the heating element 601 can be attached to the pipe 605 in other ways. The heating element 601 can function, for example, as a resistor that generates heat when current runs through it. As such, the heating element 601 can be coupled by wires to an electric power source (not shown), and one or more switches or a controller can be used to control the amount of current that runs through the heating element 601. In addition, the heating element 601 (or switch or controller, which can be considered part of the heating element) can be coupled to the control unit 100 described above so that the control unit 100 can control the heating element 601. In use, when current runs through the heating element 601, it produces heat that heats the walls of the pipe 605. The heated pipe 605, in turn, can heat the water and/or steam flow 609 through the pipe 605. In addition, the heated pipe 605 can warm the gas flow 607 through the power generation unit. As such, in one or more ways, the heating element 601 can be used to heat the power generation unit.

FIG. 6 shows one resistive heater or heating element 601 connected to one pipe 605. In other embodiments, multiple resistive heating elements 601 can be connected to each pipe 605. In addition, each pipe within a section of the power generation unit can have one or more resistive heating elements 601 attached thereto. The use of a resistive heater 601 as in FIG. 6 means that labor and retrofits may be required for the power plant. This work can be reduced if this feature is incorporated during a regularly scheduled power plant overhaul or during the design phase of the power plant. Additionally, attaching resistive heaters 601 to the piping 601 can consume space.

FIG. 6, therefore, shows one possible way to apply electric heat to a power plant. Another way to apply heat to the pipes is to cycle high amperage, high frequency power directly though the piping in order to generate inductive heating. The piping will act as the inductive coils, and an inductive drive will control the heat power introduced into the system using feedback from temperature sensors (or the other sensors described above) and a temperature control algorithm. Additionally, the water that is pumped though the pipes will act to control temperatures similar to commonly used in industrial inductive heating systems using water-cooled copper conductors for inductive heating.

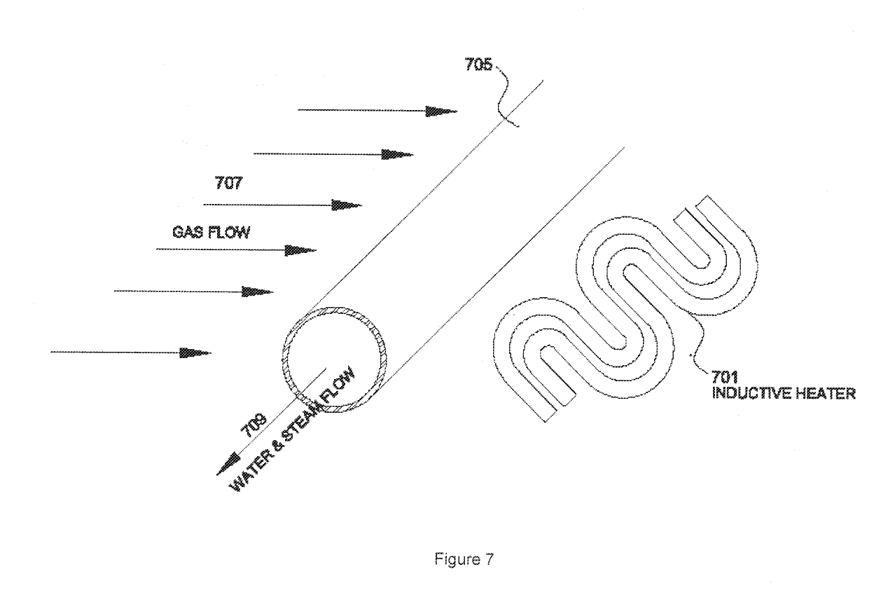

Yet another way of using an electric heater is to place an inductive heating coil in the vicinity of the piping, and the pipes will be heated via electromagnetic inductance, as is used in some commercial inductive heating systems. The inductive heating coil can be a custom-designed coil for a facility or a standard inductive heating coil. FIG. 7 shows the use of such an inductive heater 701. More particularly, FIG. 7 shows an inductive heating coil 701 adjacent a pipe 705. The inductive heater 701 can also include a power unit or source and a work head (or transformer) (not shown). The inductive heating coil, either alone or in conjunction with the power unit and work head, can be considered the inductive heater 701. In use, the inductive heater 701 produces heat that heats the pipe 705. The heated pipe 705, in turn, can heat the water and/or steam flow 709 through the pipe 705. In addition, the heated pipe 705 can warm the gas flow 707 through the power generation unit. As such, in one or more ways, the heating element 701 can be used to heat the power generation unit.

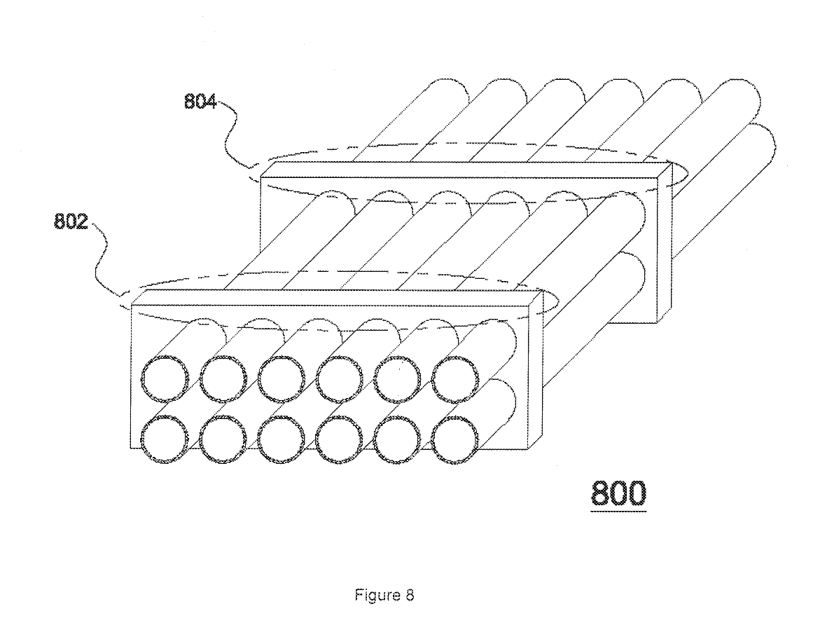

FIG. 8 illustrates another example of a section of piping 800 for a furnace superheater or furnace wall. Inductive heating contacts could be applied in the areas circled and indicated with the numerals 802 and 804. For example, alternating current would be passed between the two contacts, resulting in heating of the piping 800 shown in FIG. 8.

There is an inherent efficiency loss associated with inductive heating, such as approximately 25-75% of electric power being transferred as heat to the desired surfaces, depending primarily on geometry and the materials of the objects to be heated. High nickel materials, such as furnace and superheater piping of the power generation unit, are good candidates for inductive heating. Efficiency can be improved through computer modeling of the specific geometry of the area to be heated. This method is less labor intensive and installation requires less disassembly than a resistive heating method.

Another way to introduce electric heat to a power generation unit is via an external electric heater. Such an electric heater can be ducted into the furnace and superheaters of the power plant. The ducting can be concealed by a hatch such that gas flows under normal operation are not significantly affected. Ducting would be located such that hot air introduced would flow over the furnace walls and superheater piping, exhausting via existing exhaust ducting. Exhausted gas could be recirculated in order to reduce energy consumption needed for temperature maintenance.

The previous methods and devices can be used for electric heat applied to a coal power plant or other types of power plants. The optimum method can be selected based on a predicted cost benefit for a specific power generation unit or power plant. Installation cost may be heavily influenced by the specific design of the coal power plant or other type of power plant.

As discussed above, other embodiments of the invention can include modifications to the power generation facility to allow the facility to be placed in a heat conservation mode during electric heating. The design of many power plants involves channeling large volumes of gas from the furnace area to the exhaust of the power plant. These gas flows carry heat from the furnace to the various ducts and sections of the power plant and out the exhaust stack. When a power plant is shut down, this gas pathway represents a source of heat loss. Current technology for generating the large volumes of gas utilizes the coordination of two fans: positive pressure to introduce combustion air, via a forced draft fan, and a second fan located near the exhaust flue of the power plant called an induced draft fan. The induced draft fan creates a negative pressure within the various ducts of the power plant, resulting in controlled flow of gasses from the furnace to the exhaust flue, and also ensures that any leaks through the duct walls do not exhaust hot gasses, creating an unsafe condition for personnel and equipment outside of the hot sections of the power plant. These two “draft” systems can be used during electric heat operation to conserve heat within the power plant, therefore reducing the amount of power needed to operate the electric heaters in order to maintain a given temperature. By reducing the amount of power needed to operate the electric heaters, the operating cost of electric heating can also be reduced, thus increasing the proportion of time that electric heating is cost effective to operate.

As set forth above, the existing state of the industry is in need of improving the flexibility or ability to throttle or shut down and restart power plants. Therefore, an energy conservation mode during shut-down may include retrofits or design modifications of coal power plants or other types of power plants to modify the flows of gasses in the plant. For instance, the gas flow can be modified so that hot gasses are trapped within the power plant and heat is conserved in order to reduce the amount of electric power needed to maintain the desired temperatures under an electric heating mode (as described above).

One way to improve heat conservation is to install or retrofit a gas bypass and recirculation duct that prevents hot gasses from exiting the power plant after the induced draft fan (located near the outlet of the power plant) and then recirculating these gases back to the primary and/or secondary air ducts that enter the furnace section. These ducts can be seen in FIG. 4. These connections from the new recirculation duct to the primary and/or secondary air ducts (shown as 403 and 437 in FIG. 4) would be located upstream of the forced draft fan, because although the forced draft fan is designed to handle pre-heated air, the acceptable operating temperatures will be lower than those observed by the induced draft fan. The volume of gas to be recirculated would be much lower than the volume to be channeled during normal operation, because coal combustion produces large amounts of gas, and electric heat operation does not generate gasses. Additionally, these recirculating gases would serve to bring heat to sections of the power plant that are not directly affected via conductive or radiative heat transfer when applying electric heat via resistive and/or inductive heating, as described above.

In some embodiments, an operator of a power plant may desire not to heat sections other than those directly affected by the electric heaters and therefore choose not to recirculate gasses in the manner described above. In this scenario, exhaust gasses could be blocked to retain them within the power generation unit. Doing so, therefore reducing the escape of hot gases through the exhaust, can be done through the use of a valve, such as the one illustrated in FIG. 9. This valve 900 would function to block exhaust gasses when closed, but would not hinder gas flow when open. In use, this valve 900 can be placed at or near the exhaust flue of the power generation unit. FIG. 5, for instance, shows the location of the exhaust flue 531, and the valve 900 can be used as valve 551. The valve 900 of FIG. 9 includes a door or block 901 which, when lowered, will block gases and help retain heat. The valve 900 can also include a connection structure 903 for connection to the exhaust flue. FIG. 9 illustrates mechanical devices 905 for opening and closing the valve 900. These devices 905 can be used for secondary purposes, such as emergency purposes, or for primary use. In other embodiments, a control actuator system 907 can be affixed to the valve structure 900 so that the door 901 can be controlled remotely, such as through the control unit 100 set forth in FIG. 2.

According to the embodiments described above, one or more electric heaters can be used to keep the appropriate systems of the power plant near operating temperature during shut-down periods. Electric power from the electrical grid or from a source external to the power plant or power generation unit can be used to power the electric heaters. In addition, a valve can be used to block exhaust from an exhaust flue of the power plant in order to retain heat within the power plant to maintain the operating temperature of the power plant.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for maintaining an operating temperature of a power plant during shut-down periods, the method comprising:
(a) during shut-down of the power plant, generating heat with an electric heater in order to approximately maintain the operating temperature of the power plant;
(b) using electric power to operate the electric heater, wherein at least some of the electric power is from an electricity grid external to the power plant;
(c) receiving feedback from temperature readings of parts of the power plant;
(d) monitoring at least one of electrical prices from the electricity grid and demand for electricity; and
(e) continuing to generate heat with the electric heater as long as (i) the power plant is shut-down and the feedback from the temperature readings indicate a need to heat the power plant to approximately maintain the operating temperature of the power plant, and (ii) at least one of the electrical prices and the demand for electricity indicate that it will be more efficient to use electric power from the electricity grid to generate heat with the electric heater than to more completely shut down or restart the power plant.

2. The method of claim 1, wherein the electric heater comprises a resistive heating element.

3. The method of claim 1, wherein the electric heater comprises an inductive heating element.

4. The method of claim 1, further comprising blocking an exhaust system of the power plant to prevent hot gases from exiting the power plant.

5. The method of claim 4, wherein blocking the exhaust system includes using a valve to block hot air from exiting an exhaust flue.

6. The method of claim 1, wherein receiving feedback further comprises receiving pressure readings for pipes of the power plant, and using the pressure readings to determine the need to heat the power plant to approximately maintain the operating temperature of the power plant.

7. The method of claim 1, wherein receiving feedback further comprises receiving readings of steam and water flows in the power plant, and using the readings of steam and water flows to determine the need to heat the power plant to approximately maintain the operating temperature of the power plant.

8. The method of claim 1, wherein receiving feedback further comprises receiving readings of hot air flow in the power plant, and using the readings of hot air flow to determine the need to heat the power plant to approximately maintain the operating temperature of the power plant.

9. The method of claim 1, further comprising completely shutting down the power plant when one of the electrical prices and the demand for electricity indicate that it will be more efficient to completely shut down the power plant than to use electric power from the electricity grid to generate heat with the electric heater.

10. The method of claim 1, further comprising restarting the power plant after a period of time in which the electric heater is used to generate heat in order to approximately maintain the operating temperature of the power plant during shut-down.

11. A heating system for maintaining an operating temperature of a power plant during shut-down periods, the system comprising:
(a) an electric heater to generate heat to approximately maintain the operating temperature of the power plant during shut-down of the power plant, wherein the electric heater uses electric power from an electricity grid external to the power plant; and
(b) a control system to: (i) receive feedback from temperature readings of parts of the power plant, (ii) monitor electrical prices from the electricity grid, and (iii) continue to generate heat with the electric heater as long as the power plant is shut-down and the feedback from the temperature readings and the electrical prices indicate that it will be more efficient to use electric power from the electricity grid to generate heat with the electric heater than to more completely shut down or restart the power plant.

12. The system of claim 11, wherein the electric heater comprises a resistive heating element.

13. The system of claim 11, wherein the electric heater comprises an inductive heating element.

14. The system of claim 11, further comprising a valve to block an exhaust system of the power plant to prevent hot gases from exiting the power plant, wherein the control system controls the valve.

15. The system of claim 11, wherein the control system can further receive feedback from one or more of temperature readings, pressure readings, steam and water flow readings, and hot air flow readings, and wherein the control system uses one or more of the pressure readings, temperature readings, steam and water flow readings, and hot air flow readings to determine the need to heat the power plant to approximately maintain the operating temperature of the power plant.

16. A method for maintaining an operating temperature of a power generation unit during shut-down periods, the method comprising:
(a) during shut-down of the power generation unit, generating heat with an electric heater in order to approximately maintain the operating temperature of the power generation unit;
(b) using electric power to operate the electric heater, wherein the electric power is from a power unit that is external to the power generation unit;
(c) receiving feedback from operational readings of parts of the power generation unit; and
(d) continuing to generate heat with the electric heater as long as the power plant is shut-down and the feedback from the operational readings requires generation of heat to approximately maintain the operating temperature.

17. The method of claim 16, wherein the operational readings comprise one or more of temperature readings, pressure readings, steam and water flow readings, and hot air flow readings.

18. The method of claim 16, wherein the electric heater comprises a resistive heating element.

19. The method of claim 16, wherein the electric heater comprises an inductive heating element.

20. The method of claim 16, further comprising blocking an exhaust system of the power plant to prevent hot gases from exiting the power plant.
